(19) United States
(12) Patent Application Publication
(10) Pub. No.: US 2005/0132497 A1
(43) Pub. Date: Jun. 23, 2005

(54) Spring core

(76) Inventor: Gerd-Uwe Schmidt, (US)

Correspondence Address: Gauthier & Connors LLP, Suite 3300, 225 Franklin Street, Boston, MA, 02110, US

(21) Appl. No.: 10/957,929

(22) Filed: Oct. 4, 2004

(30) Foreign Application Priority Data
Oct. 15, 2003 (DE) 10347906.6

(51) Int. Cl. H01F 3/12; H01F 7/08

(52) U.S. Cl. 5/716

(57) ABSTRACT

A spring core having a plurality of springs wound in screw fashion and arranged next to one another in axially parallel fashion, laterally bounded at each of the top and the bottom by a peripheral frame made of metal, preferably steel, which frame is connected to adjacent springs is so fashioned that each frame is formed from flat steel with a thickness (A) to width (B) ratio of 1:2.2 to 1:3.5, the extension direction of the wide side of the frame corresponding to that of the top or bottom of the spring core.

### PRIORITY INFORMATION

This application claims priority to German Patent Application DE10347906.6-16, filed on Oct. 15, 2003.

### BACKGROUND OF THE INVENTION

1. Field of Invention

The present invention relates to a spring core having a plurality of springs wound in screw fashion and arranged next to one another in axially parallel fashion, laterally bounded at each of the top and respectively the bottom by a peripheral frame made of metal, preferably steel, which frame is connected to adjacent springs.

2. Description of Prior Art

Such spring cores find use in many application fields. Their primary use is in the manufacture of mattresses or furniture cushions.

In order to achieve adequate edge stability, which is desired particularly when the cushion or mattress is utilized for seating, it is known to fabricate the frame from a round stock, preferably a round steel, the diameter of the round stock usually lying between 3.8 and 4.8 mm.

In order to finish the end product, that is, mattress or cushion part, the spring cores usually must be transported from the place of manufacture to the mattress factory, the several production facilities possibly lying very far from one another in space.

By their nature, the spring cores in the service position occupy a relatively large volume while at the same time being light in weight. As a result, of course, the transportation costs for the spring cores are disproportionately high, having a detrimental effect on total manufacturing costs, which include transportation costs.

In order to achieve better space utilization in the transportation vehicle and thus reduce transportation costs, the frames of a spring core are therefore formed from a narrow strip of sheet stock, so that the so-far-finished spring core can be rolled up, the springs of the spring core being fully compressed. Rolling up in this way is not possible with a frame made of the round stock mentioned.

After unrolling of the spring core into a service position, the frames extend themselves because of the remanent restoring forces.

Because of its sizing, however, the frame of this spring core, made up for example of a strip of sheet stock 10 mm wide and 1.4-1.7 mm thick, does not exhibit the desired edge stability, which naturally impairs the user-friendliness of the spring core or of the cushion part manufactured therefrom.

### SUMMARY OF THE INVENTION

It is therefore an object of the invention to improve a spring core of the type stated at the outset in such a way as to improve its handling qualities and serviceability.

This object is achieved with a spring core having the features of a plurality of springs wound in screw fashion and arranged next to one another in axially parallel fashion, laterally bounded at each of the top and respectively the bottom by a peripheral frame made of metal, preferably steel. The frame is connected to adjacent springs wherein each frame is formed from flat steel with a thickness (A) to width (B) ratio of 1:2.2 to 1:3.5, the extension direction of the wide side of the frame corresponding to that of the top or bottom of the spring core.

As has surprisingly been found, the fashioning of the spring core in this way leads to the result, first, that it can be rolled up without difficulty for further transportation immediately after manufacture and can then be unrolled into a flat position, for further use.

At the same time, by virtue of the thickness to width ratio of the frame, a high degree of edge stability is achieved because the resisting moment and thus the flexural stiffness are higher than in the prior art, in which, as mentioned, a strip of sheet stock is employed.

Sizing of the frame with a thickness of roughly 2.3 mm and a width of roughly 6.0 mm has proved especially advantageous.

Likewise, advantageous is a size of roughly 2.1 mm thick and roughly 6.3 mm wide, that is, a ratio of 1:3, the possible deviations in the stated measurements being capable of varying in the range of tenths of a millimeter.

In order to attain a sufficient righting moment, a steel with a high carbon content, for example 0.5-1.0% C, and with a tensile strength of roughly 2000 N/mm² is selected. The modulus of elasticity of this steel is greater than that of the steel formerly used, so that the stated improvement of the righting moment is obtained.

Further advantageous developments are characterized in the dependent Claims.

### BRIEF DESCRIPTION OF THE DRAWINGS

An exemplary embodiment of the invention is described in what follows with reference to the appended Drawings, in which:

FIG. 1 depicts a portion of a spring core in an overhead view;

FIG. 2 depicts an individual spring connected to the frames in a lateral view; and

FIG. 3 depicts an enlarged detail according to II in FIG. 2.

### DETAILED DESCRIPTION OF THE INVENTION

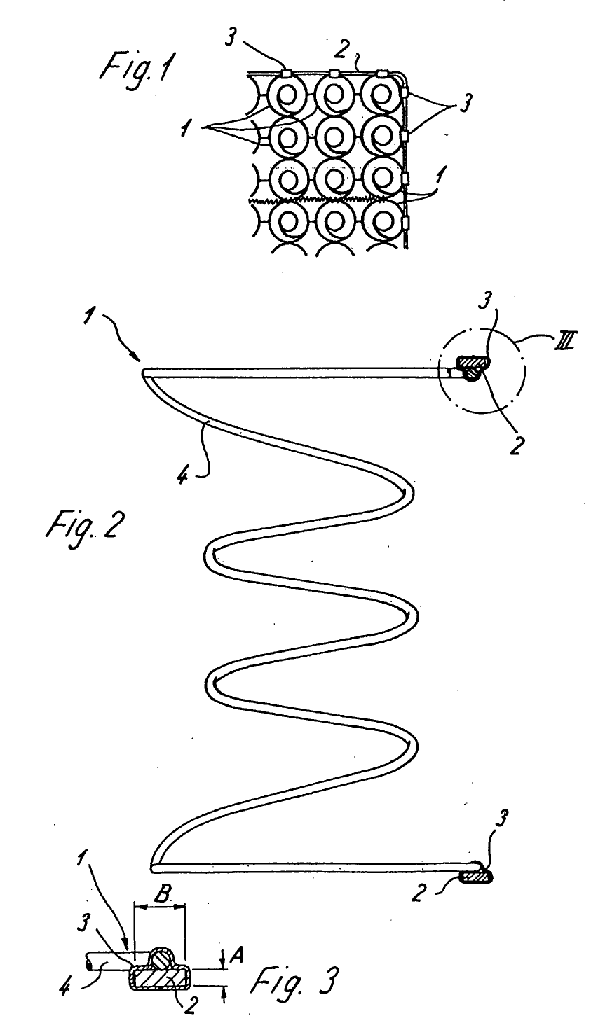

FIG. 1 shows a portion of a spring core having a plurality of springs wound in screw fashion, arranged next to one another in axially parallel fashion and connected to one another.

At each of the top and the bottom, the spring core is laterally bounded by a metal frame 2, adjacent springs 1 being attached to frame 2 by clips 3.

Clip 3 encloses frame 2 and a bearing wire 4 of spring 1, from which wire the clip is formed.

According to the invention, the peripheral frames 2 are made of flat steel whose thickness A is in a ratio of 1:2.2 to 1:3.5 to its width B, preferably in a ratio of 1:2.6 or respectively 1:3. The extension direction of the wide side of frame 2 corresponds to that of the top or bottom of the spring core, as can be seen especially clearly in FIG. 2.

Instead of individual springs 1 being attached to frames 2 by clips 3, of course, other ways of attachment are also possible, provided, however, that such ways of attachment render the two parts connected to each other immovable.

What is more, as in the present exemplary embodiment, frame 2 can abut spring 1 on top or underneath. It is also possible, however, that frame 2 lies laterally beside wire 4.

1. A spring core having a plurality of springs wound in screw fashion and arranged next to one another in axially parallel fashion, laterally bounded at each of the top and respectively the bottom by a peripheral frame made of metal, preferably steel, which frame is connected to adjacent springs, wherein each frame is formed from flat steel with a thickness (A) to width (B) ratio of 1:2.2 to 1:3.5, the extension direction of the wide side of the frame corresponding to that of the top or bottom of the spring core.

2. Spring core according to claim 1, wherein the thickness (A) to width (B) ratio of the frame is roughly 1:2.6.

3. The Spring core according to claim 1, wherein the thickness (A) to width (B) ratio of the frame is 1:3.

4. The Spring core according to claim 1, wherein the thickness (A) is roughly 2.3 mm and the width (B) is roughly 6.0 mm.

5. The Spring core according to claim 1, wherein the thickness (A) is roughly 2.1 mm and the width (B) is roughly 6.3 mm.

6. The Spring core according to claim 1, wherein the frame is made up of a carbon steel with 0.5-1.0% carbon.

7. The Spring core according to claim 1, wherein the flat steel has a tensile strength of roughly 2000 N/mm².
